(19) United States
(12) Patent Application Publication
(10) Pub. No.: US 2021/0203207 A1
(43) Pub. Date: Jul. 1, 2021

(54) Modern Curtain Driving Device

(71) Applicant: NINGBO SUNFREE MOTOR TECHNOLOGY COMPANY LIMITED, Ningbo (CN)

(72) Inventors: Chun JIANG, NINGBO (CN); Baoguo TAN, NINGBO (CN)

(21) Appl. No.: 17/117,794

(22) Filed: Dec. 10, 2020

(30) Foreign Application Priority Data
Dec. 31, 2019 (CN) 201922497815.6

(51) Int. Cl. H02K 5/22; H02K 11/33; A47H 5/02

(52) U.S. Cl. CPC H02K 5/225; H02K 2207/03; A47H 5/02; H02K 11/33

(57) ABSTRACT

A modern curtain driving device is provided which comprises a power module, a control module and a tubular motor, wherein it further comprises a connecting terminal seat; the connecting terminal seat comprises a vertical part, and a horizontal part; the horizontal part comprises an accommodating cavity for installing the power module and the control module; and the tubular motor is installed on the vertical part and is parallel to the horizontal part. Additionally, being separated from the tubular motor, the control module is more stable for receiving signals and the separated arrangement of the tubular motor from the power module and the control module, the tubular motor is diverse in length design, and thus more suitable for both long and short roller blinds.

### CROSS-REFERENCE TO RELATED APPLICATIONS

This application claims priority to Chinese Patent Application No. 201922497815.6 with a filing date of Dec. 31, 2019. The content of the aforementioned applications, including any intervening amendments thereto, are incorporated herein by reference.

### TECHNICAL FIELD

The present disclosure relates to the technical field of curtain accessories, in particular to a modern curtain driving device.

### BACKGROUND

With scientific and technological progress and improvement of living standard, household products have become more and more automated and intelligentized. Compared with traditional curtains such as bead curtains, venetian blinds and fabric curtains which are all hand-driven and basically opened and closed with hands, more and more electric-driven curtains such as electric-driven roller blinds are emerging in the market. For these electric-driven roller blinds, a motor rotates to drive the roller tubes of the roller blinds to rotate so as to open or close the curtains. The motor in the conventional electric-driven roller blinds is tubular, featuring in small diameter and convenience in mounting by merely being inserted into the roller tube of the roller blinds. Currently, the tubular motor available in the market has a minimum diameter of 15 mm and in order to match its small diameter, the size of the electric elements installed in the tubular motor has to be strictly limited, thus more expensive cost required. Further, the tubular motor is equipped with an outer tube which didn't provide enough inner space to accommodate a power supply, and even if the power supply is reluctant to be disposed therein, some potential safety risks may be caused. Besides, as an intelligentized era approaches, more intelligentized chips may need to be placed in the tubular motor, the limited tube diameter makes it difficult to include these chips which severely affecting the intelligentized development of curtains. Usually, one will prolong the length of the tubular motor to accommodate more chips, however, the length of the curtain will also be changed. The prolonged tubular motor is not suitable for short curtains any more. Furthermore, the outer tube of the tubular motor is usually made of metal which may bring about signal interference to the intelligentized chips in the tube and affect intelligentized control.

### SUMMARY

One objective of the present disclosure is to overcome the shortcomings of the prior arts by providing a modern curtain driving device, which comprises a power module, a control module and a motor, and the power module, the control module and the motor are placed separately, with the advantages of large mounting space, better signal strength and flexibility in suiting both long and short roller blinds in the aspect of length.

The technical solution adopted to solve the abovementioned technical problem of the present disclosure discloses a modern curtain driving device, which comprises a power module, a control module and a tubular motor, and it further comprises a connecting terminal seat; the connecting terminal seat comprises a vertical part, and a horizontal part; the horizontal part comprises an accommodating cavity for installing the power module and the control module; and the tubular motor is installed on the vertical part and is parallel to the horizontal part.

In one embodiment, the accommodating cavity is internally provided with a division plate dividing the accommodating cavity into a first accommodating cavity for installing the power module and a second accommodating cavity for installing the control module.

In one embodiment, one end of the tubular motor, the end of which away from the vertical part is provided with a transmission head for driving the roller tube to rotate, and one end, the end of which close to the vertical part is sleeved with a driven sleeve for connecting the roller tube.

In one embodiment, the power module, the control module and the tubular motor are electrically connected with one another.

In one embodiment, the control module comprises an interface, and the interface is exposed on the lateral wall of the horizontal part.

In a preferred embodiment, the control module comprises a switch, and the switch is exposed on the horizontal part.

In a preferred embodiment, the control module comprises a setup key, and the setup key is exposed on the lateral wall of the horizontal part.

In a preferred embodiment, the top of the accommodating cavity is provided with a detachable cover plate.

In a preferred embodiment, one end of the horizontal part, the end of which away from the vertical part is provided with a connection part by extension.

In a preferred embodiment, the connecting terminal seat is made of plastics.

As compared to the prior art, the modern curtain driving device provided in the disclosure has the following advantages that by arranging the power module and the control module on the horizontal part of the connecting terminal seat, and the tubular motor on the vertical part of the connecting terminal seat, so that the power module, the control module and the tubular motor are separately arranged, in turns the power module and the control module have acquired larger mounting space and more intelligentized chips can be contained, as a result, the curtains gained more potential to be equipped to be more intelligentized. Additionally, being separated from the tubular motor, the control module is more stable for receiving signals and the separated arrangement of the tubular motor from the power module and the control module, the tubular motor is diverse in length design, and thus more suitable for both long and short roller blinds.

### BRIEF DESCRIPTION OF THE DRAWINGS

FIG. 1 is a schematically structural diagram of the present disclosure;

FIG. 2 is an exploded view of the present disclosure;

FIG. 3 is a schematic diagram of the present disclosure in a use state.

The numerals depict: 1 power module; 2 control module; 2.1 interface; 2.2 switch; 2.3 setup key; 3 tubular motor; 4 connecting terminal seat; 4.1 horizontal part; 4.2 vertical part; 4.3 division plate; 4.4 first accommodating cavity; 4.5 second accommodating cavity; 4.6 cover plate; 4.7 connection part; 5 transmission head; 6 driven sleeve; 7 roller tube; 8 curtain mounting rack; 9 connector.

### EMBODIMENTS

Various aspects of the illustrative embodiments herein will be described below using terms commonly employed by those skilled in the art to convey the substance of their work to others stilled in the art. However, it will be apparent to those skilled in the art that alternate embodiments may be practiced with only some of the described aspects. For purposes of explanation, specific numbers, material and configuration are set forth in order to prove a thorough understanding of the illustrative embodiments. However, it will be apparent to one skilled in the art that alternate embodiments may be practiced without the specific details. In other instances, well-known features are omitted or simplified in order not to obscure the illustrative embodiments.

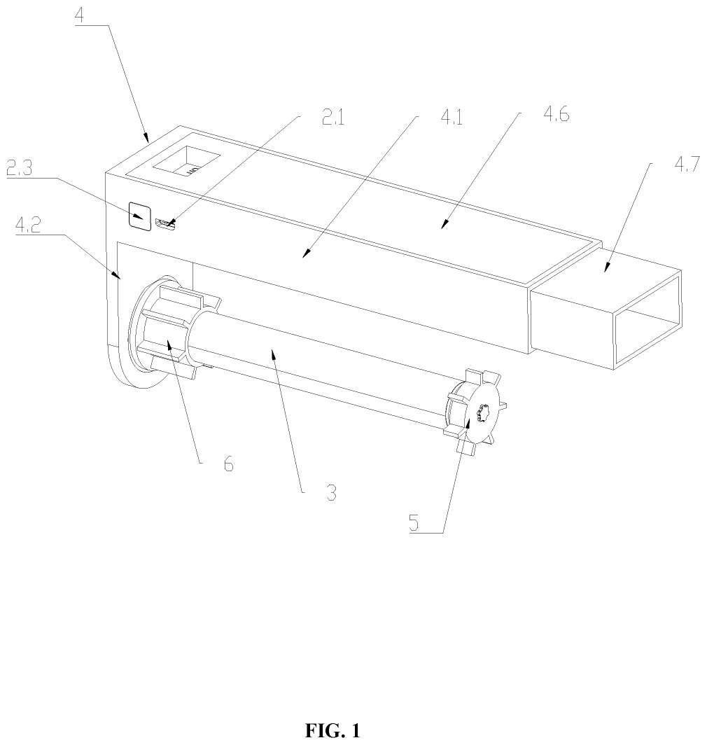

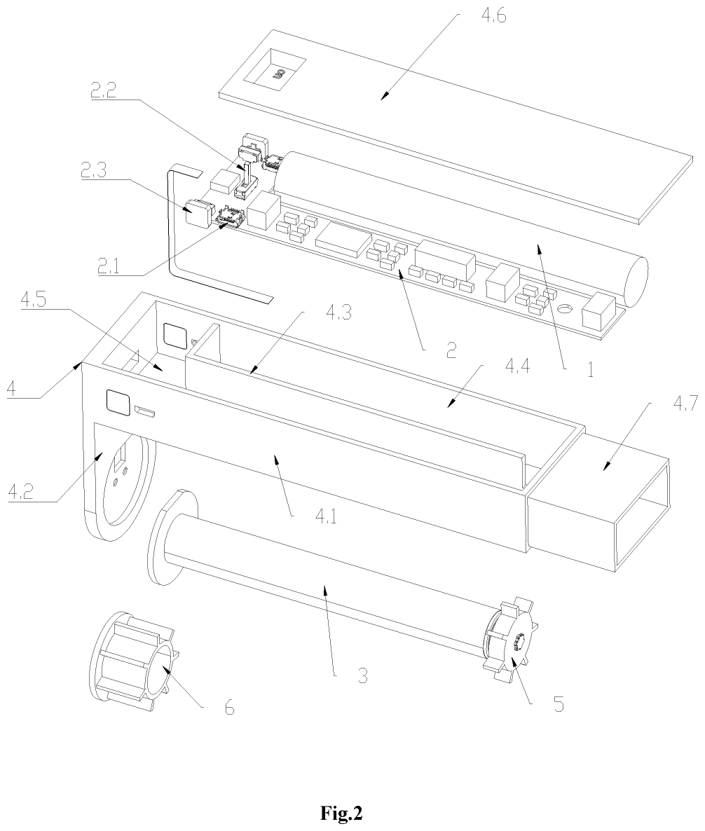

As shown in FIGS. 1-2, a modern curtain driving device, comprises a power module 1, a control module 2 and a tubular motor 3, and it further comprises a connecting terminal seat 4; the connecting terminal seat 4 comprises a vertical part 4.2, and a horizontal part 4.1 where the power module 1 and the accommodating cavity of the control module 2 are arranged; and the tubular motor 3 is arranged on the vertical part 4.2 and parallel to the horizontal part 4.1.

The power module 1 and the control module 2 are arranged on the horizontal part 4.1 of the connecting terminal seat 4, and the tubular motor 3 is arranged on the vertical part 4.2 of the connecting terminal seat 4, such that the power module 1 and the control module 2 as well as the tubular module 3 are separately arranged, thus the power module 1 and the control module 2 have large mounting space and more intelligentized chips can be contained, as a result, the curtains become more intelligentized. Additionally, after separation from the tubular motor 3, the control module 2 is stable to receive signals. Due to the separated arrangement of the tubular motor 3 from the power module 1 and the control module 2, the tubular motor 3 is diverse in length design, and thus suitable for both long and short roller blinds, thereby being applicable to windows of various sizes.

The accommodating cavity is internally provided with a division plate 4.3 dividing the accommodating cavity into a first accommodating cavity 4.4 for accommodating the power module 1 and a second accommodating cavity 4.5 for accommodating the control module 2. The arrangement of the division plate 4.3 facilitates fixing the power module 1.

One end of the tubular motor 3 away from the vertical part 4.2 is provided with a transmission head 5 for driving a roller tube 7 to rotate, a driven sleeve 6 for connection with the roller tube 7 sleeves one end of the tubular motor 3 close to the vertical part 4.2, the transmission head 5 drives the roller tube 7 to rotate, and the driven sleeve 6 assists the roller tube 7 in rotation.

The power module 1, the control module 2 and the tubular motor 3 are electrically connected with one another. Preferably, the control module 2 and the tubular motor 3 are connected via a flat cable which penetrates through the interior of the vertical part 4.2 of the connecting terminal seat 4, without damaging the whole mounting beautiful degree. The control module 2 has an interface 2.1 exposed on the lateral wall of the horizontal part 4.1 and used for charging and communication. Preferably, there are two interfaces 2.1 symmetrically exposed on two lateral walls of the horizontal part 4.1, so people are convenient to charge or read information. The control module 2 has a switch 2.2 exposed on the top or lateral wall of the horizontal part 4.1 for switching on/off a power supply, so people are convenient to switch on the switch. The control module 2 also has a setup key 2.3 exposed on the lateral wall of the horizontal part 4.1 and used for code matching, motor commutation or restoring factory settings. Preferably, there are two setup keys 2.3 symmetrically exposed on two lateral walls of the horizontal part 4.1, bringing convenience for operation.

The top of the accommodating cavity is provided with a detachable cover plate 4.6 whereby people are convenient to detect, maintain or replace the power module 1 and the control module 2 in the accommodating cavity. One end of the horizontal part 4.1 away from the vertical part 4.2 is provided with a connection part 4.7 by extension, for connection with a curtain mounting rack 8, so assembly is convenient.

The connecting terminal seat 4 is made of plastics. For one thing, a plastic shell has an insulated effect, being safe and reliable; for another thing, during wirelessly controlling a curtain, the plastic shell avoids signal shielding so as to ensure better wireless control signals.

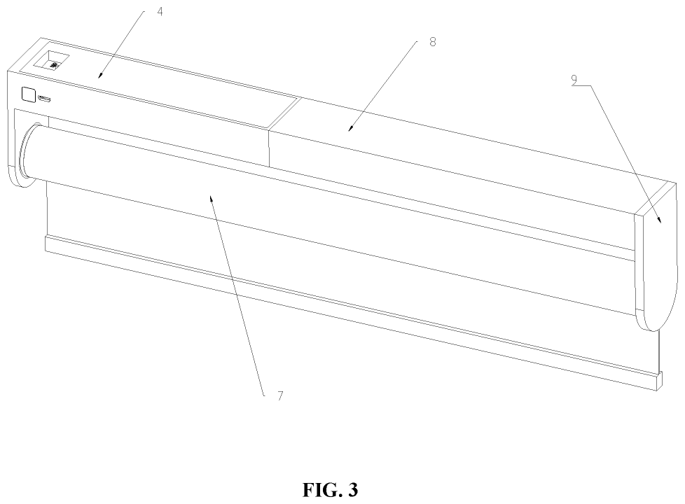

When in use, the roller tube 7 directly sleeves the tubular motor 3 so that the transmission head 5 and the driven sleeve 6 are clamped on the inner wall of the roller tube 7; and then the connection part 4.7 of the connecting terminal seat 4 is inserted into the curtain mounting rack 8, and the curtain mounting rack 8 is connected with the other end of the roller tube 7 via the connector 9, at this time, the curtain is well assembled. As shown in FIG. 3, after assembly, the switch 2.2 is switched on, the curtain is debugged by the setup key 2.3, a remote controller transmits a signal to the control module 2, the control module 2 controls the tubular motor 3 to operate and the tubular motor 3 drives the roller tube 7 to rotate so as to achieve automatic lifting of the curtain. The power module 1 and the tubular motor 3 are both available in the market, and the control module 2 is also comprised by circuit boards and electric elements that can be purchased in the market. Therefore, detailed repetition is avoided.

It should be noted that, the above embodiments are merely illustrative, rather than restrictive, to the technical solutions of the present disclosure. Although the present disclosure has been explained in detail with reference to the above embodiments, it should be understood by those skilled in the art that, modifications to the technical solutions of the embodiments or even equivalent substitutions for partial technical features therein are allowed. However, these modifications or substitutions shall not make the essence of the technical solutions depart from the spirit and scope defined by the technical solutions of the present disclosure.

We claim:

1. A modern curtain driving device, comprising: a power module, a control module and a tubular motor, wherein it further comprises a connecting terminal seat; the connecting terminal seat comprises a vertical part, and a horizontal part; the horizontal part comprises an accommodating cavity for installing the power module and the control module; and the tubular motor is installed on the vertical part and is parallel to the horizontal part.

2. The modern curtain driving device of claim 1, wherein the accommodating cavity is internally provided with a division plate dividing the accommodating cavity into a first accommodating cavity for installing the power module and a second accommodating cavity for installing the control module.

3. The modern curtain driving device of claim 1, wherein one end of the tubular motor, the end of which away from the vertical part is provided with a transmission head for driving the roller tube to rotate, and one end, the end of which close to the vertical part is sleeved with a driven sleeve for connecting the roller tube.

4. The modern curtain driving device of claim 1, wherein the power module, the control module and the tubular motor are electrically connected with one another.

5. The modern curtain driving device of claim 4, wherein the control module comprises an interface, and the interface is exposed on the lateral wall of the horizontal part.

6. The modern curtain driving device of claim 4, wherein the control module comprises a switch, and the switch is exposed on the horizontal part.

7. The modern curtain driving device of claim 4, wherein the control module comprises a setup key, and the setup key is exposed on the lateral wall of the horizontal part.

8. The modern curtain driving device of claim 1, wherein the top of the accommodating cavity is provided with a detachable cover plate.

9. The modern curtain driving device of claim 1, wherein one end of the horizontal part, the end of which away from the vertical part is provided with a connection part by extension.

10. The modern curtain driving device of claim 1, wherein the connecting terminal seat is made of plastics.
